(19) United States
(12) Patent Application Publication
(10) Pub. No.: US 2010/0091861 A1
(43) Pub. Date: Apr. 15, 2010

(54) Method and apparatus for efficient image compression

(76) Inventor: Chih-Ta Star Sung, Glonn (DE)

Correspondence Address: Chih-Ta Star SUNG, RM. 308, BLD. 52, NO. 195, CHUNG HSING RD., SEC. 4, JHU DONG TOWNSHIP, HSINCHU COUNTY, 310, TW

(21) Appl. No.: 12/287,633

(22) Filed: Oct. 14, 2008

(51) Int. Cl. H04N 7/26

(52) U.S. Cl. 375/240.16; 375/E07.124

(57) ABSTRACT

The invention provides method and apparatus of video bit stream encoding. In non-intra type encoding, block pixel differences between a target block and the corresponding best match block is compared to other blocks' to determine whether a bit stream of a previously compressed block can be used to represent a target block. In Intra-coding, a target block is compared to other blocks to determine whether a bit stream of a previously compressed block can represent the target block. A variable length code is applied to represent the tables of coding the predetermined sub-band DC coefficients.

### BACKGROUND OF THE INVENTION

1. Field of Invention

The present invention relates to still image and motion video compression, and, more specifically to the efficient DCT coefficient coding method and apparatus that results in the saving of the computing times with higher coding efficiency.

2. Description of Related Art

Digital image and video have been adopted in an increasing number of applications, which include digital camera, scanner/printer, video telephony, videoconferencing, surveillance system, VCD (Video CD), DVD, and digital TV. In the past almost two decades, ISO and ITU have separately or jointly developed and defined some digital image and video compression standards including JPEG, MPEG-1, MPEG-2, MPEG-4, MPEG-7, H.261, H.263 and H.264. The success of development of the video compression standards fuels the wide applications. The advantage of image and video compression techniques significantly saves the storage space and transmission time without sacrificing much of the image quality.

Most ISO and ITU motion video compression standards adopt Y, Cb and Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8x8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-frame or P-frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

In most video compression standards including the MPEG 1, MPEG 2 or MPEG 4, there are six to eight syntactical layers of video streams which includes video sequence, group of pictures (GOP), picture, slice, macroblock and block layers. FIG. 1 gives an overview of the six layers in most of MPEG video compression standards. The system layer packs and packets synchronize and multiplex the audio and video bit streams into an integrated data stream. A video stream 11 always starts with a sequence header 12. The sequence header is followed by at least one or more groups of pictures (GOP) 13 and ends with a “sequence end code” 115. Additional sequence headers may appear between any groups of pictures within the video sequence. A group of pictures, GOP always starts with a GOP header 14 and is followed by at least one picture 15. Each picture in the GOP has a picture header 16 followed by one or more slices 17. In term, each slice is composed of a slice header 18 and one or more groups of so named “macroblocks” 19. The 1^{st} slice starts from the upper left corner of a picture and the last slice ends in the lower right corner. The macroblock 110 is composed of a group of six 8×8 DCT blocks 111—four blocks contain luminance, Y samples and two contain chrominance, Cb, Cr samples. Each macroblock starts with a macroblock header 110 containing information about which DCT blocks are actually coded. All six blocks are shown in FIG. 1 even though in practice, some of the blocks might not be coded. DCT blocks are coded as intra or non-intra, referring to whether the block is coded with respect to a block from another picture or not. If an intra block is coded, the difference 112 between the DC coefficient and the prediction is coded first. The AC coefficients are then coded by using the variable-length codes (VLC) 113 for the packed “Run-Level” pairs until an “end-of-block” 114 terminates the block encoding.

FIG. 3 depicts the procedure of the JPEG, an international standard of a still image compression algorithm. Both JPEG and MPEG have some common procedure and method in compressing the image including:
Adopting DCT, discrete cosine transform
Quantization: with different quantization steps
Adopting Huffman, an variable length coding method to represent the [Run-Length] pair.
   In both image and video compression standards, the JPEG and MPEG, the conventional approaches consume high computing power. And both still have room for improvement in the compression ratio under a certain bit rate.

This invention provides an efficient bit stream encoding method specifically for the reduction of computing time in the motion compensation as well as an efficient method of DCT coefficient coding for both still image and motion video compression.

### SUMMARY OF THE INVENTION

The present invention is related to a method and apparatus of the image and video data encoding, which plays an important role in digital still image, JPEG and motion video compression, specifically in encoding the MPEG video stream. The present invention significantly reduces the computing times compared to its counterparts in the field of image and video compression.
The present invention of the efficient video bit stream encoding includes procedures and steps of quickly screening the pixel data within a frame, a GOB (group of blocks), and an macro-block to determine whether or not the plurality of a frame, a GOB or a macro-block need to go through the steps of the video compression.
The present invention of the efficient video bit stream encoding saves the previously compressed blocks bit stream and determines which bit stream of the previously compressed blocks can be used to represent the bit stream of a target block to avoid the video compression steps.
The present invention of the efficient video bit stream encoding compares the block pixel differences starting from the neighboring blocks and more quickly determines which bit stream of the previously compressed blocks can be used as the bit stream of the present.
The present invention determines that “skip block” code can be applied to blocks having no movement with very little or no change of pixel values or blocks having the same motion vector as the frame motion vector with no or very little change.
The present invention determines that if the DC coefficient can efficiently represent the block difference, then the rest of AC coefficient are rounded to be all “0s” and an “EOB code, end of block” is followed to represent the completion of a block encoding.
The present invention of the efficient video bit stream encoding efficiently calculates the MAD and the average of the block pixel differences between a target block and the best match block, and determines whether the neighboring blocks can skip the video compression procedures.
After identifying that the DC coefficient can efficiently represent the block pixel differences, the present invention use a look-up table to determine the DC value of the DCT coefficients for representing the block difference.
The present invention compares the block pixel differences between a target block and its surrounding blocks to determine whether the block pixel differences are small enough to avoid the compression steps by copying the bit stream of one of the neighboring blocks to represent the target block.
According to an embodiment of the present invention of the efficient DCT coefficient coding, tables with variable code length are applied to represent the corresponding DCT coefficient of each sub-band of the corresponding coefficient.
According to an embodiment of the present invention of the efficient DCT coefficient coding, high bit rate is applied to represent the less frequent happened sub-band DCT coefficients and shorter code to represent the less frequent sub-band DCT coefficients.

It is to be understood that both the foregoing general description and the following detailed description are by examples, and are intended to provide further explanation of the invention as claimed.

### BRIEF DESCRIPTION OF THE DRAWINGS

FIG. 1 shows the layers of the MPEG bit stream which includes from top to down: the sequence layer, group of picture (GOP) layer, picture layer, slice layer, macroblock layer and block layer.

FIG. 2 is a simplified block diagram of the prior art video compression encoder, which is commonly used in most MPEG encoder system.

FIG. 3 is an illustration of the procedure of JPEG, the commonly used still image compression.

FIG. 4 depicts the block diagram of the present invention of the efficient bit stream encoding. In this block diagram, the output of the compressed video block data stream are saved into a storage device to determine whether the future blocks can re-use it.

FIG. 5 depicts a table of the DCT coefficients of an 8×8 block of pixels.

FIG. 6 depicts an efficient method of coding the DCT coefficient according to the present invention with a fixed length of coding for each band of DCT frequency.

FIG. 7 depicts an efficient method of coding the DCT coefficient according to the present invention with a variable length of coding for each band of DCT frequency and a code called “End of Block” (EOB) in this present invention.

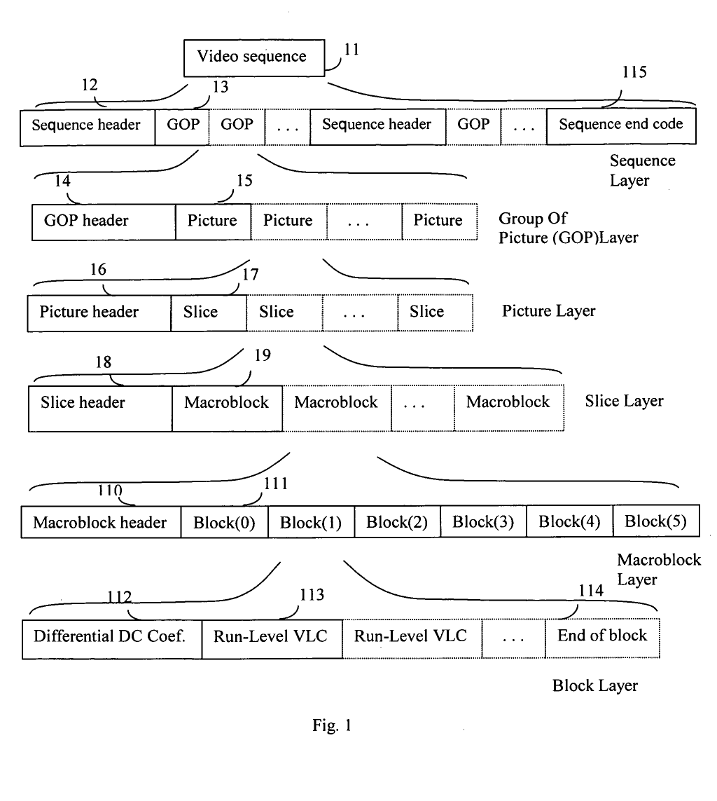

### DESCRIPTION OF THE PREFERRED EMBODIMENTS

The present invention relates specifically to the video bit stream encoding. The method and apparatus quickly encodes the block bit stream data, which results in a significant saving of the computing times.

There are in principle three types of picture encoding in the MPEG video compression standard including I-frame, the “Intra-coded” picture, P-frame, the “Predictive” picture and B-frame, the “Bi-directional” interpolated picture. I-frame encoding uses the 8×8 block of pixels within a frame to code information of itself. The P-frame or P-type macro-block encoding uses previous I-frame or P-frame as a reference to code the difference. The B-frame or B-type macro-block encoding uses previous I- or P-frame as well as the next I- or P-frame as references to code the pixel information. In most applications, since the I-frame does not use any other frame as reference and hence no need of the motion estimation, the image quality is the best of the three types of pictures, and requires least computing power in encoding. Because of the motion estimation needs to be done in both previous and next frames, bi-directional encoding, encoding the B-frame has lowest bit rate, but consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. Therefore, the encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

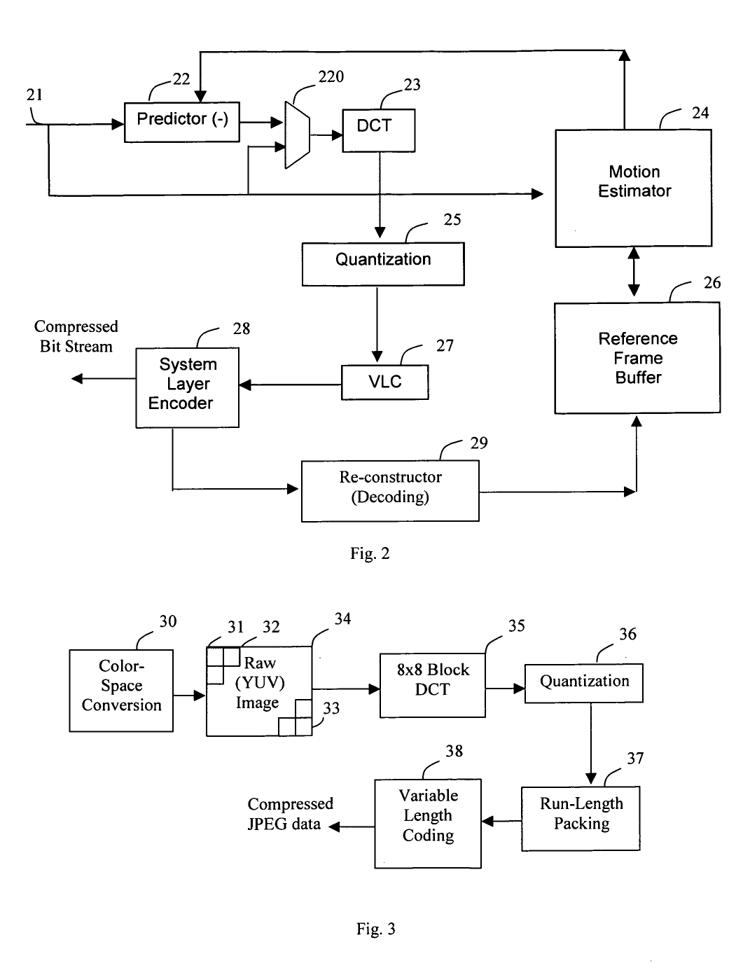

FIG. 2 illustrates the block diagram and data flow of the digital video compression procedure, which is commonly adopted by compression standards and system vendors. This video encoding module includes several key functional blocks: The predictor 22, DCT 23, the Discrete Cosine Transform, quantizer 25, VLC encoder 27, Variable Length encoding, motion estimator 24, reference frame buffer 26 and the re-constructor (decoding) 29. The MPEG video compression specifies I-frame, P-frame and B-frame encoding. MPEG also allows macro-block as a compression unit to determine which type of the three encoding means for the target macro-block. In the case of I-frame or I-type macro block encoding, the MUX 220 selects the coming pixels 21 to go to the DCT 23 block, the Discrete Cosine Transform, the module converts the time domain data into frequency domain coefficient. A quantization step 25 filters out some AC coefficients farer from the DC corner which do not dominate much of the information. The quantized DCT coefficients are packed as pairs of “Run-Level” code, which patterns will be counted and be assigned code with variable length by the VLC Encoder 27. The assignment of the variable length encoding depends on the probability of pattern occurrence. The compressed I-type or P-type bit stream will then be reconstructed by the re-constructor 29, the reverse route of compression, and will be temporarily stored in a reference frame buffer 26 for future frames' reference in the procedure of motion estimation and motion compensation. In the case of a P-frame, B-frame or a P-type, B-type macro block encoding, the coming pixels 21 of a macroblock are sent to the motion estimator 24 to compare with pixels of previous frames (and the next-frame in B-type frame encoding) to search for the best match macro-block. Once the best match macro-block is identified, the Predictor 22 calculates the block pixel differences between the target 8×8 block and the block within the best match macro-block of previous frame (or next frame in B-type encoding). The block pixel differences then feed into the DCT 23, quantizer and VLC encoder, the same procedure like the I-frame or I-type block encoding.

JPEG image compression as shown in FIG. 3 includes some procedures in compression. The color space conversion 30 is to separate the luminance (brightness) from chrominance (color) and to take advantage of human being's vision less sensitive to chrominance than to luminance and the can reduce more chrominance element without being noticed. An image 34 is partitioned into many units of so named “Block” of 8×8 pixels to run the JPEG compression.

A color space conversion 30 mechanism transfers each 8×8 block pixels of the R(Red), G(Green), B(Blue) components into Y(Luminance), U(Chrominance), V(Chrominance) and further shifts them to Y, Cb and Cr. JPEG compresses 8×8 block of Y, Cb, Cr 31, 32, 33 by the following procedures:
Step 1: Discrete Cosine Transform (DCT)
Step 2: Quantization
Step 3: Zig-Zag scanning
Step 4: Run-Length pair packing and
Step 5: Variable length coding (VLC).

DCT 35 converts the time domain pixel values into frequency domain. After transform, the DCT “Coefficients” with a total of 64 sub-bands of frequency represent the block image data, no long represent single pixel. The 8×8 DCT coefficients form the 2-dimention array with lower frequency accumulated in the left top corner, the farer away from the left top, the higher frequency will be. Further on, the closer to the left top, the more DC frequency which dominates the more information. The more right bottom coefficient represents the higher frequency which less important in dominance of the information. Like filtering, quantization 36 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss. The larger the quantization step, the higher the compression and the more distortion the image will be.

After quantization, most DCT coefficient in the right bottom direction will be rounded to “0s” and only a few in the left top corner are still left non-zero which allows another step of said “Zig-Zag” scanning and Run-Length packing 37 which starts left top DC coefficient and following the zig-zag direction of scanning higher frequency coefficients. The Run-Length pair means the number of “Runs of continuous 0s”, and value of the following non-zero coefficient.

The Run-Length pair is sent to the so called “Variable Length Coding” 38 (VLC) which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lossless compression. JPEG is a lossy compression algorithm, the JPEG picture with less than 10× compression rate has sharp image quality, 20× compression will have more or less noticeable quality degradation.

The JPEG compression procedures are reversible, which means the following the backward procedures, one can decompresses and recovers the JPEG image back to raw and uncompressed YUV (or further on RGB) pixels. The main disadvantage of JPEG compression algorithm is the input data are sub-sampled and the compression algorithm itself is a lossy algorithm caused by quantization step which might not be acceptable in some applications

The block pixel differences between a target block and the best match block are coded by going through the DCT, quantization and VCL encoding. The procedure of calculating the block MV and encoding the block pixel differences is called “Motion Compensation”. The DCT and quantization together consumes about 20% computing power. The VLC encoding consumes around 5-10%, while the motion compensation dominates about another 5%-10% of the total computing power.

The DCT, Discrete Cosine Transform consumes the high times of computing in most image and video compression standards. DCT equation is shown as below:

$$F ( i , j ) = \frac{1}{\sqrt{2 N}} C ( i ) C ( j ) {\sum }_{x = 0}^{N - 1} {\sum }_{y = 0}^{N - 1} f ( x , y ) cos \frac{( 2 x + 1 ) i π}{2 N} cos \frac{( 2 y + 1 ) j π}{2 N}$$

After the DCT transform, the more close to the left top corner AC coefficients, dominates more information. From the other hand, the closer to the right bottom, the less information the AC coefficient dominates. Therefore, the AC farer away from the DC and left top corner can be filtered out to be “0s” by quantization step without sacrificing much image quality.

If the block pixel difference range is smaller than an adaptively predetermined threshold, after the quantization with a predetermined quantization scale which is decided by the image quality and buffer, bit rate controller, then all AC coefficients are filtered out to be 0s and only the DC coefficient is left. If there is only DC left, then a very short “End of Block”, EOB, said “000”” code is assigned to represent the completeness of the block encoding.

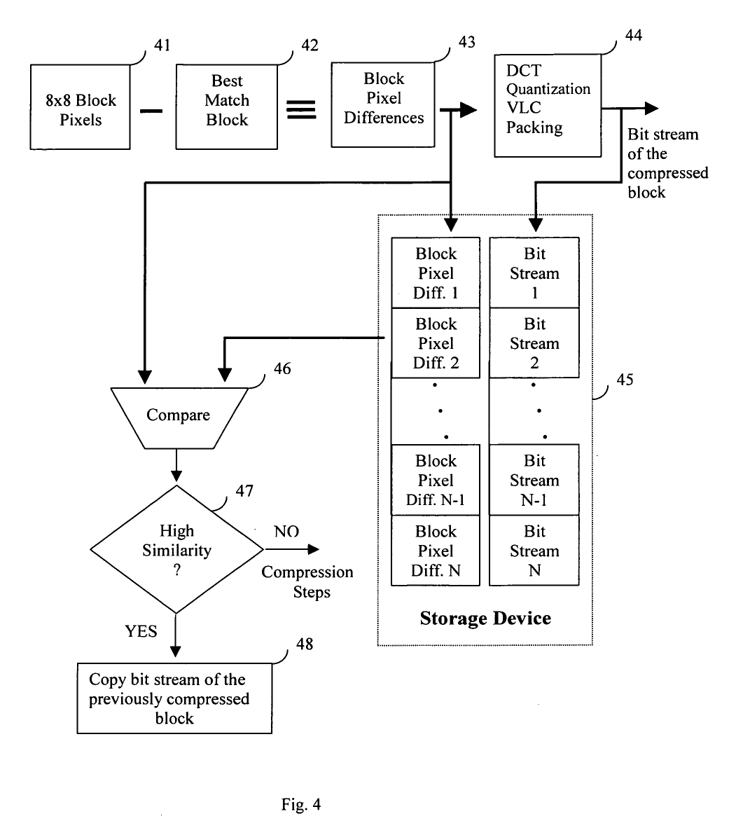

FIG. 4 illustrates the method and mechanism of the block pixel differences comparison which results in the significant saving of computing times in the P-type and B-type frame or macroblock compression. After identifying the best match block through the procedure of the motion estimation, the block pixel differences 43 between the target block 41 and the corresponding best match block 42 is calculated and compared 46 to those of the previously saved block differences. Through the block by block comparing, if the similarity of any of the block pixel difference is high 47, the bit stream of the previously compressed block difference is copied to represent the target block's block pixel difference. If the degree of similarity is not high, then, the block needs to go through the complete compression procedure, the DCT, quantization, VLC and data packing and being saved into the storage device 45 for future block difference comparison. In our simulation of video sequences, depending on the quantization step and the precision in defining the “similarity”, the 1584 CIF (each block consists of 352×288 pixels) blocks of pixels have been reduced to be about 100 to 600 patterns of blocks which are saved in the storage device 45. This represents a 2.67× to 16.0× saving of computing times.

Similar mechanism to the video compression as described above can be applied to the JPEG compression except for the differential block pixel calculation. In JPEG, each block pixels can look at left or upper row of blocks of pixels to identify whether a block has similarity or identical values to the target block and can represent the target block without running the procedures of the image compression hence can reduce the times of computing.

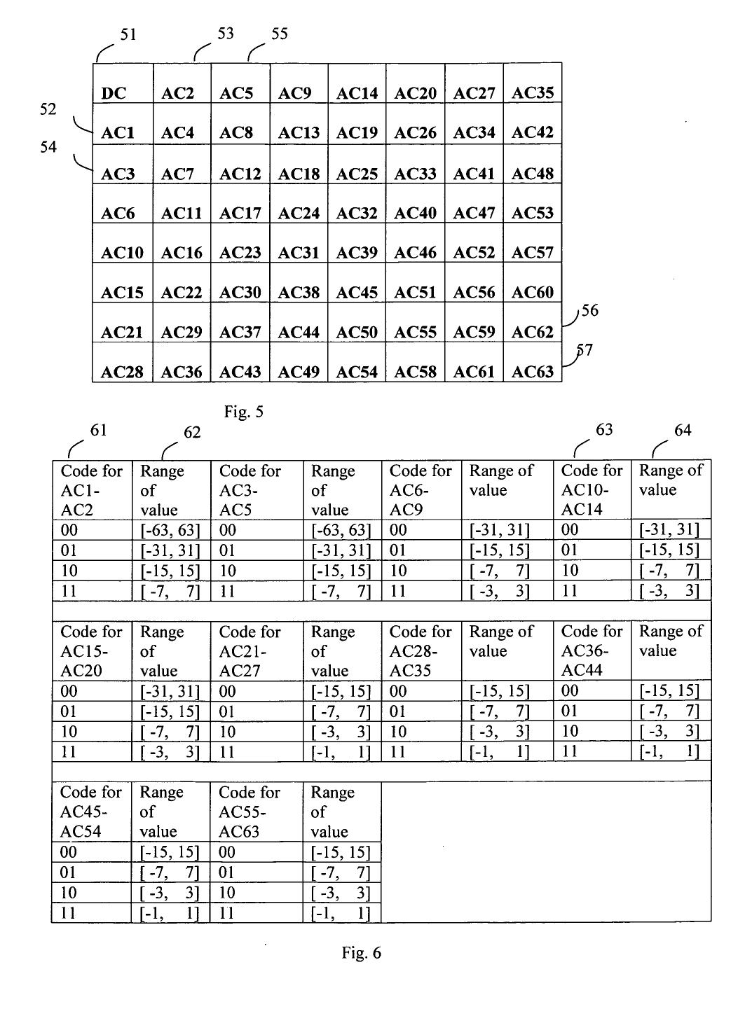

FIG. 5 shows the DCT coefficients of an 8×8 block of pixels. In coding the DCT coefficient including DC coefficient 51, AC1 52, AC2 53, AC3 54 AC5 55 . . . . The higher the frequency, AC62 56, AC63 57, the less important they dominate the information. One of an embodiment of the present invention of coding the DCT coefficients as shown in FIG. 6 is to apply predetermined fixed length code to represent the corresponding sub-band of DCT coefficients. For example, the DC coefficient 61 can used 2 bits to represent four ranges 62 of values like “00” for range [−63, +63], “01” for range [−31, +31], “10” for range [−15, +15], “11” for range [−7, +7], in that corresponding range, a predetermined fixed can be used to represent the value of the DC coefficient. For instance, “01111111” represents “+31”, “110101” represents “−5” . . . etc. Another table can be identified to represent DCT coefficients 63, AC10, AC11, AC12, AC13 and AC14 by applying code of “00” representing for range [−31, +31], “01” for range [−15, +15], “10” for range [−7, +7], “11” for range [−3, +3] 64 and all five sub-bands DCT coefficients, AC10-AC14 adopt this table to code the 4 ranges. Another example as the following more clearly describe the way of coding the DCT AC coefficients: AC10=6, AC11=3, AC12=−2, AC13=0, AC14=−1, since they range from −1 to 6 which is within [−7,+7], the sequence code to represent these 5 sub-band AC coefficients will be: one 2-bit code of “10” representing range of [−7,+7] followed by 5 values of 4-bit codes, 1010, 1011, 0010, 1000 and 0001 representing values of 6, 3, −2, 0, and −1. In higher frequency, the less range can be needed and the shorter codes are expected.

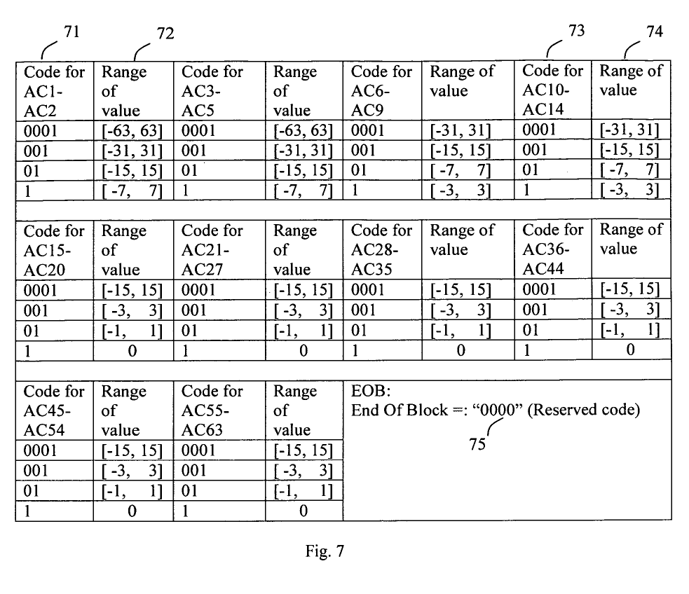

An optimized coding method of this invention is to apply variable code to represent the tables of DCT coefficient coding of each sub-band 71, 73 as shown in FIG. 7. Since the higher frequency the higher quantization step will be applied to filter out the values which results in narrower range of DCT coefficient values. Applying the variable code length to represent the range 72, 74 of the DCT coefficient values of sub-bands of most frequent happen range gains higher coding efficiency.

An example as illustrated in the following more clearly describes the way of applying the variable length of code the DCT AC coefficients: AC10=3, AC11=0, AC12=−2, AC13=3, AC14=−3, since they range from −3 to 3 which is within [−3,+3], the sequence code to represent these 5 sub-band AC coefficients will be: one 1-bit code of “0” representing range of [−3,+3] followed by 5 values of 3-bit codes, 111, 100, 010, 111 and 011 representing values of 3, 0, −2, 3 and −3 resulting in a shorter code length.

After quantization, the higher frequency DCT coefficients have high possibility of being rounded to “0s”. For the block coding, there is a chance that from a certain AC coefficient, no longer non-zero coefficient, which is very common and using a short code like “0000” to represent “End Of Block” 75 can easily achieve short code length.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method for encoding an image or a motion video bit stream, comprising:
storing a compressed bit stream of at least one previous block in the first storage device and the corresponding block pixel differences in the second storage device;
in the still image coding: transforming block pixel values from time domain to frequency domain values;
in the motion video coding: calculating block pixel differences between a target block and the corresponding best match block of pixels and transforming the block pixel differences to frequency domain values;
comparing the transformed block values to previous blocks saved in the first storage device; and
representing the bit stream of the target block with the bit stream of a previously compressed block of pixels temporarily stored in the second storage device.

2. The method of claim 1, further comprising a step for representing a target frame with a compressed bit stream of a neighboring frame if a sum or an average of differences of selected pixels between the target frame and at least one neighboring frame is within a predetermined threshold value.

3. The method of claim 2, wherein a threshold value is compared to block pixel differences of at least two blocks within the target frame for determining similarity of a target frame to at least one neighboring frame.

4. The method of claim 1, wherein a “skip block” code is assigned to represent a target block if the block pixel differences between a target block and the corresponding target best match block is less than a predetermined threshold.

5. The method of claim 1, wherein in the case that block pixel differences between a target block and the corresponding best match block is similar to block pixel differences of a previously compressed block and the corresponding best match block, then the saved bit stream of a previously compressed block is used to represent a target block.

6. A method for compressing a block of pixel components, comprising:
separately transforming the block of pixels of time domain information, YUV or RGB into frequency domain information;
applying the predetermined codes to represent tables of fixed length of codes for the coding of the transformed coefficients of the corresponding sub-bands; and
assigning a predetermined code to represent “no more non-zero coefficient”.

7. The method of claim 6, wherein the frequency transform method includes discrete cosine transform (or said the DCT) and discrete wavelet transform (DWT).

8. The method of claim 6, wherein the DC of the DCT or DWT coefficients of block pixel differences between a target block and the corresponding best match block is represented by a predetermined value by comparing the average or sum of the block pixel differences to predetermined values.

9. The method of claim 6, wherein the DC of the DCT or DWT coefficients of block pixel differences between a target block and the corresponding best match block is represented by a predetermined value by comparing the average or sum of the block pixel differences to predetermined values.

10. The method of claim 6, wherein a variable length of code is applied to represent the tables of predetermined sub-band frequency values with shorter code representing narrower range of sub-band data and longer code representing wider range of sub-band data.

11. The method of claim 6, wherein a predetermined code is reserved to represent no more non-zero coefficient within the targeted block of pixel components.

12. An apparatus for encoding a video stream, comprising:
a first storage device for storing the block pixels and corresponding compressed bit stream of at least one previous block;
a second storage device for storing the predetermined threshold values;
a device for determining the selection of output bit stream; and
an encoding device for utilizing the compressed bit stream of a previous block to represent a compressed bit stream of a target block.

13. The apparatus of claim 12, wherein the block pixel differences between a target block and the corresponding best match block is compared to the block pixel differences of previously compressed blocks and the corresponding best match blocks to determine whether the previously saved bit stream of a previously compressed block can represent the targeted block.

14. The apparatus of claim 12, wherein the DC of DCT coefficients of block pixel differences between a target block and the corresponding best match block is represented by a predetermined value.

15. The apparatus of claim 12, wherein a bit stream of an intra-coded block is represented by a saved bit stream of a previously compressed block if the block pixel differences between a target block and the previously compressed block is less than a predetermined value.
